(19) United States
(12) Patent Application Publication
(10) Pub. No.: US 2013/0235160 A1
(43) Pub. Date: Sep. 12, 2013

(54) OPTICAL PULSE SHAPING

(71) Applicants: David Cohen, Nesher (IL); Erez Tadmor, Tel Aviv (IL); Shlomo Felzenshtein, Nesher (IL); Avishai Adler, Kiryat Haim (IL)

(72) Inventors: David Cohen, Nesher (IL); Erez Tadmor, Tel Aviv (IL); Shlomo Felzenshtein, Nesher (IL); Avishai Adler, Kiryat Haim (IL)

(73) Assignee: MICROSOFT CORPORATION, Redmond, WA (US)

(21) Appl. No.: 13/413,230

(22) Filed: Mar. 6, 2012

(51) Int. Cl. H04N 7/18; H04N 13/02

(52) U.S. Cl. 348/46; 348/140; 348/E13.074; 348/E07.085

(57) ABSTRACT

An embodiment of the invention relates to providing a method of illuminating a scene imaged by a camera, which includes illuminating the scene with a train of light pulses and adjusting exposure times of the camera relative to transmission times of the light pulses so that the light pulses emulate a light pulse having a desired pulse shape.

### TECHNICAL FIELD

Embodiments of the invention relate to shaping optical pulses.

### BACKGROUND

A time of flight (TOF) three dimensional (3D) camera acquires distances to features in a scene that the camera images by timing how long it takes temporally modulated light that it transmits to illuminate the scene to travel and make a “round trip” to the features and back to the camera. The known speed of light and the round trip time to a given feature in the scene is used to determine a distance of the given feature from the TOF 3D camera.

In a “gated” TOF 3D camera, a train of light pulses may be transmitted by a light source to illuminate a scene that the camera images. Upon lapse of a predetermined same delay interval, hereinafter an “exposure delay”, after each light pulse in the train of light pulses is transmitted, the camera is shuttered, or “gated” ON, for a short exposure period that ends when the camera is shuttered, or “gated”, OFF. The camera images light reflected from the transmitted light pulses by features in the scene that reaches the camera during each exposure period and is incident on pixels of the camera's photosensor. Distance to a feature in the scene imaged on a pixel of the photosensor is determined as a function of an amount of light that the feature reflects from the transmitted light pulses that is registered by the pixel during the exposure periods.

Light reflected by a feature in the scene from a transmitted light pulse in the train of light pulses reaches the TOF 3D camera as a reflected light pulse having pulse width and pulse shape substantially the same as the pulse width and pulse shape respectively of the transmitted light pulse from which it was reflected. Pulse shape of a light pulse refers to intensity of light in the light pulse as a function of location along the light pulse width, or to intensity of light in the light pulse on a surface on which the light pulse is incident as a function of time.

Sensitivity of pixels in the TOF 3D camera photosensor for registering light in the reflected light pulse during an “associated” exposure period following the transmitted light pulse is a function of time. The function is generally substantially equal to zero at the shutter ON and OFF times that define the exposure period and has a maximum at some time between the ON and OFF times. A shape of a curve representing the sensitivity function is referred to as a “shape” of the exposure period.

An amount of light in the reflected light pulse that is registered by the pixel imaging the feature during the associated exposure period is proportional to a convolution between the reflected light pulse and the exposure period. The convolution is a function of a round trip time for light to propagate to the feature and back to the gated TOF 3D camera. An amount of reflected light registered by the pixel for all the reflected light pulses incident on the pixel from the feature measures a sum of the convolutions between the shapes of the reflected light pulses and their respective associated exposure periods, and may be used to determine distance to the feature. Accuracy and resolution of distances provided by a TOF 3D camera generally improve as the transmitted light pulses and thereby the reflected light pulses are matched to the exposure periods to have similar or substantially same shapes.

Hereinafter, for convenience of presentation a convolution between the shape of a light pulse and an exposure period is referred to as a convolution between the light pulse and the exposure period.

### SUMMARY

An aspect of an embodiment of the invention relates to providing a method of exposing a camera to light from a light pulse having a desired pulse shape by adjusting timing of light pulses that provide light to which the camera is exposed relative to exposure periods of the camera so that the light pulses emulate a light pulse having the desired pulse shape. An amount of light from the light pulses registered by the camera during the exposure periods is substantially the same as an amount of light that would be registered by the camera from a single light pulse having the desired pulse shape during a single exposure period of the camera.

In an embodiment of the invention, the camera is a TOF 3D camera and the light pulses are light pulses in a train of light pulses transmitted by a light source in the TOF 3D camera to illuminate a scene that the TOF 3D camera images. The exposure periods are the associated exposure periods of the TOF 3D camera, each of which follows a transmission time of a transmitted light pulse in the train of light pulses upon lapse of an exposure delay.

To provide a desired pulse shape, in accordance with an embodiment of the invention, exposure delays between transmission times of light pulses in the train of light pulses and ON times of their associated respective exposure periods of the TOF 3D camera are adjusted by different perturbation periods. The perturbation periods are chosen so that were the light pulses in the train of light pulses ordered in time relative to a common time origin by their perturbation periods and added together, they would provide a compound light pulse, hereinafter an “emulated light pulse”, having the desired pulse shape. Adding light pulses together refers to adding their pulse shapes or their intensities.

In an embodiment of the invention, the desired pulse shape of the emulated light pulse is similar to, or substantially the same as, the shape of the exposure periods. In an embodiment of the invention, the pulse shape of the emulated light pulse is advantageously higher at the leading edge than at the trailing edge to compensate, at least partly, for decrease in intensity of reflected light from features that are farther from the TOF 3D camera.

As a result of the perturbation periods, reflected light pulses from features in the scene reach the TOF 3D camera at arrival times relative to the ON time of the exposure periods that are functions not only of round trip times of light to and back from the features, but also of the perturbation periods. Light reflected from each transmitted light pulse by a given feature in the scene arrives at the TOF 3D camera following a delay from a transmission time of the transmitted light pulse that is equal to a sum of the perturbation delay associated with the transmitted light pulse as well as the round trip time of light to and back from the given feature. A sum of the convolutions of each reflected light pulse from the given feature and its associated exposure period is also a function of the perturbation periods. The “sum convolution” is equal to a convolution of the pulse shape of the emulated light pulse provided by the “time perturbed” transmitted light pulses and a single exposure period.

A distance to the given feature determined responsive to the sum convolution in accordance with an embodiment of the invention, may therefore be provided by the TOF 3D camera responsive to a convolution of the shape of the exposure periods of the TOF 3D camera with a light pulse having a desired, advantageous pulse shape.

In the discussion, unless otherwise stated, adjectives such as “substantially” and “about” modifying a condition or relationship characteristic of a feature or features of an embodiment of the invention, are understood to mean that the condition or characteristic is defined to within tolerances that are acceptable for operation of the embodiment for an application for which it is intended.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF FIGURES

Non-limiting examples of embodiments of the invention are described below with reference to figures attached hereto that are listed following this paragraph. Identical structures, elements or parts that appear in more than one figure are generally labeled with a same numeral in all the figures in which they appear. Dimensions of components and features shown in the figures are chosen for convenience and clarity of presentation and are not necessarily shown to scale.

FIG. 1A schematically shows a TOF 3D camera imaging a scene to determine distances to features in the scene;

FIG. 1B shows a timeline graph that illustrates relative timing of light pulses in a train of light pulses transmitted by the TOF 3D camera shown in FIG. 1A, light pulses reflected by features in the scene, and exposure periods of the TOF 3D camera;

FIG. 2 shows a timeline graph that illustrates relative timing of light pulses in a train of light pulses different from those illustrated in FIG. 1B, light pulses reflected by features in the scene and exposure periods of the TOF 3D camera;

FIGS. 3A and 3B shows timeline graphs that illustrate configuring and using an emulated light pulse to determine distances to features in the scene shown in FIG. 1A, in accordance with an embodiment of the invention; and

FIG. 4 schematically shows an emulated light pulse having a pulse shape advantageous for compensating for decrease in intensity of reflected light pulses that are reflected by distant features to a TOF 3D camera, in accordance with an embodiment of the invention.

### DETAILED DESCRIPTION

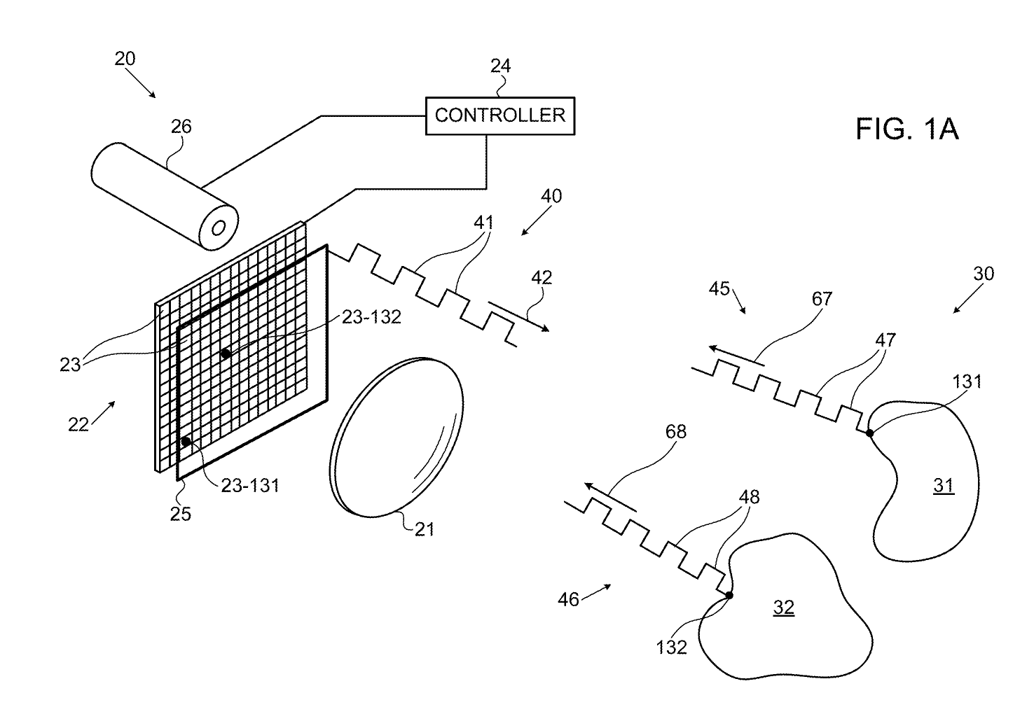

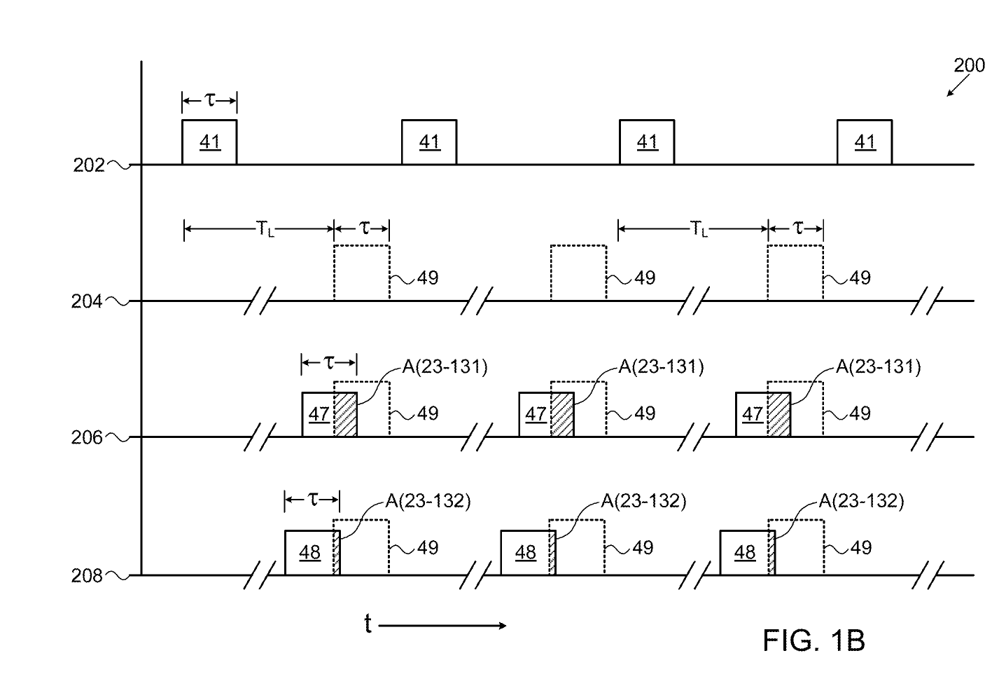

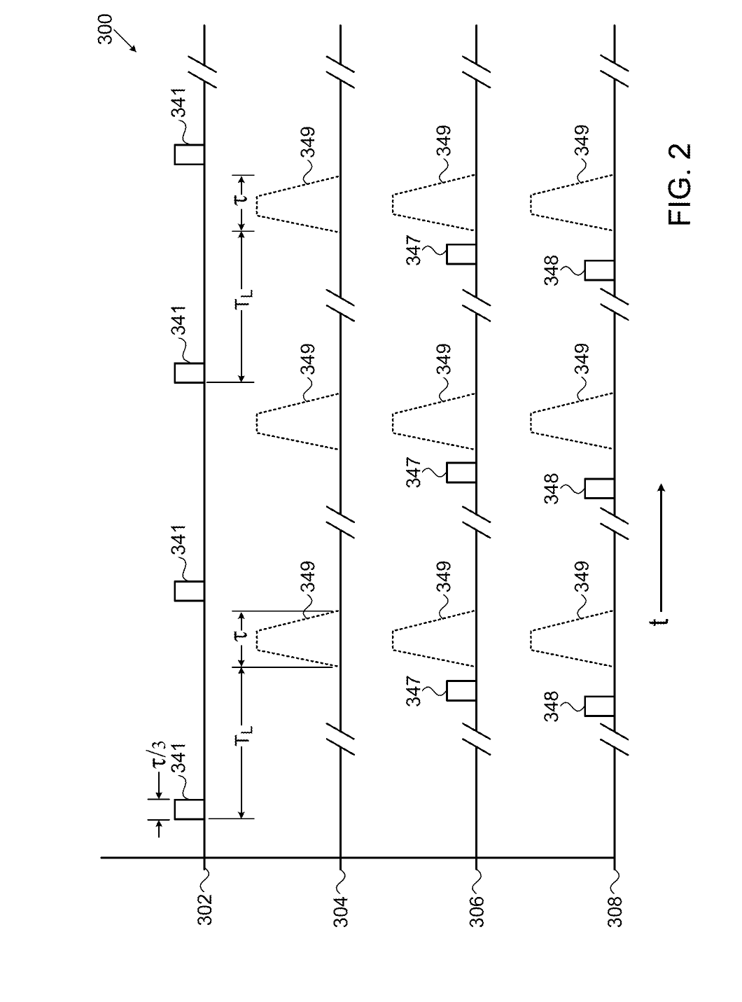

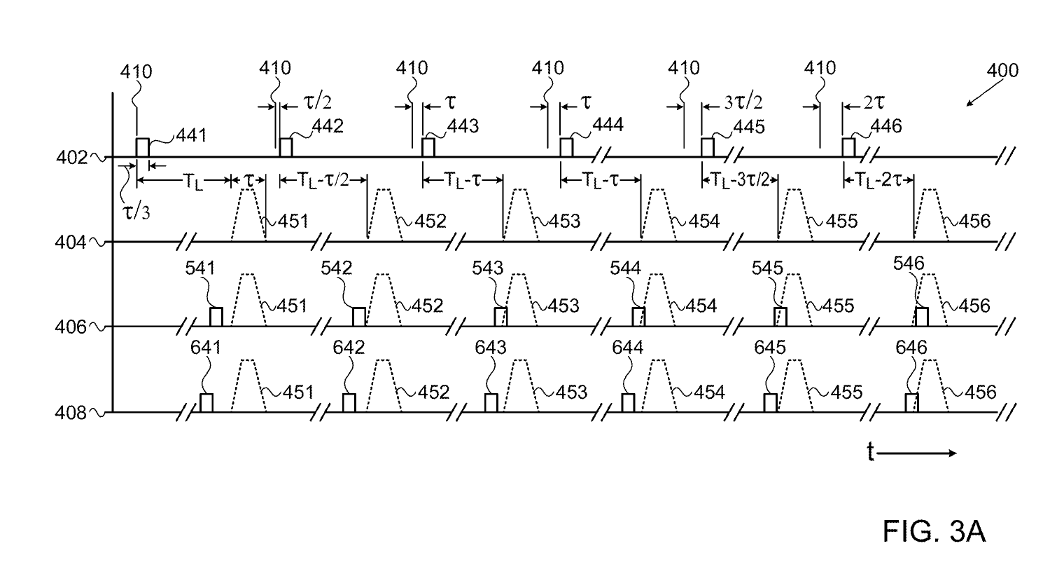

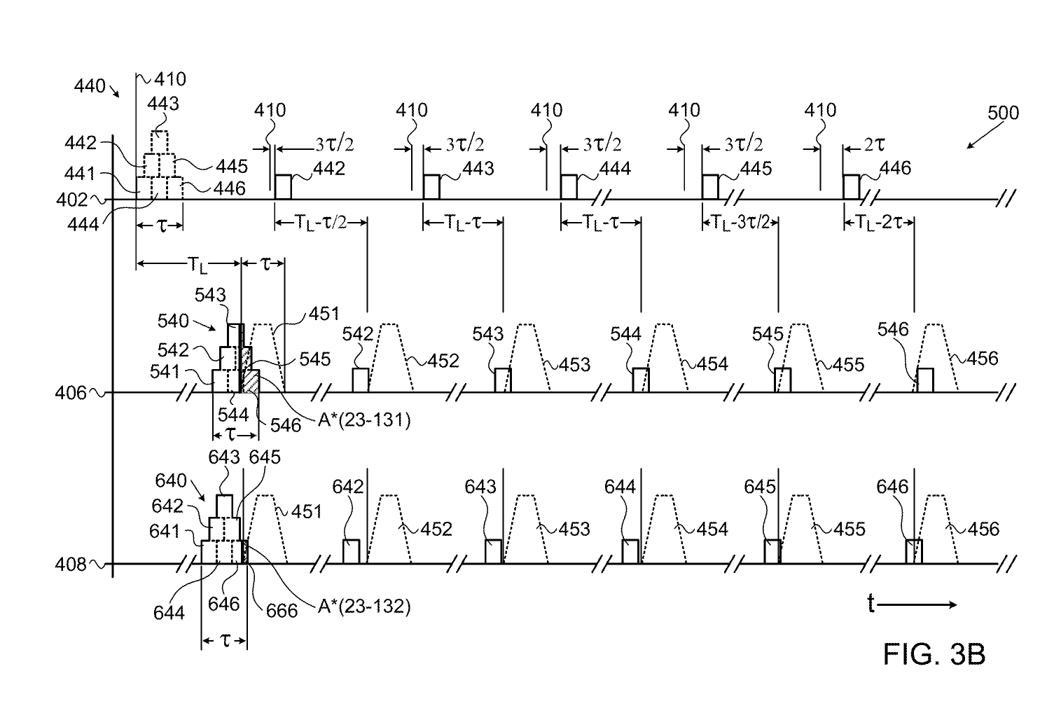

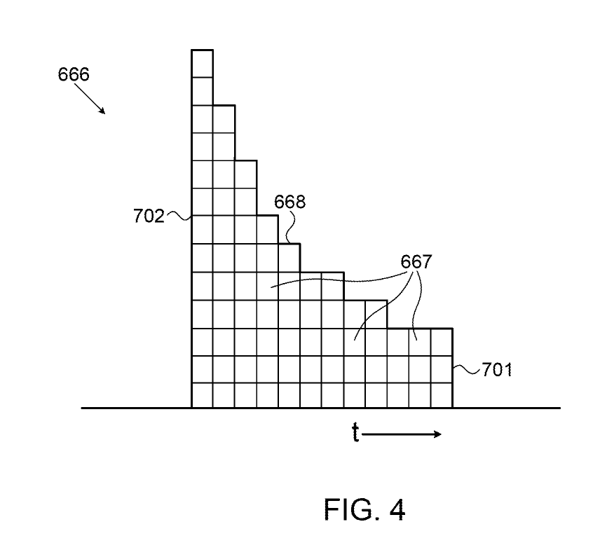

In the following text of the detailed description, features of a TOF 3D camera are shown in FIG. 1A and discussed with reference to the figures. Operation of the TOF 3D camera shown in FIG. 1A is discussed with reference to a timeline graph shown in FIG. 1B. The timeline graph illustrates timing of transmission times of transmitted light pulses used to illuminate a scene imaged by the TOF 3D camera shown in FIG. 1A and timing relationships between light reflected from the transmitted light pulses and exposure periods of the camera. In the timeline graph of FIG. 1B the transmitted light pulses have shape and duration that are substantially the same as the shape of the exposure periods. FIG. 2 shows a timeline graph illustrating relative timing of exposure periods, transmitted light pulses, and reflected light pulses for transmitted light pulses that have pulse widths different from duration of the exposure periods. FIGS. 3A and 3B graphically illustrate configuring transmission times of light pulses in accordance with an embodiment of the invention to generate an emulated light pulse shaped similar to a shape of exposure periods of the TOF 3D camera. FIG. 4 schematically illustrates an emulated light pulse in accordance with an embodiment of the invention that is configured to compensate, at least partly, for reduction in intensity of light received from features of a scene that a camera images that are relatively far from the camera.

FIG. 1A schematically shows a gated TOF 3D camera 20 being used to determine distances to features in a scene 30 having objects 31 and 32. TOF 3D camera 20, which is represented very schematically, comprises an optical system, represented by a lens 21, and a photosensor 22 having pixels 23 on which the lens system images scene 30. TOF 3D camera 20 optionally comprises a shutter 25 for shuttering the camera ON and OFF, a light source 26, and a controller 24 that controls shutter 25 and light source 26. Whereas TOF 3D camera 20 is schematically shown having a shutter 25 separate from photosensor 22, a TOF 3D camera may comprise a photosensor that includes circuitry operable to shutter ON and shutter OFF the photosensor and thereby the camera. A reference to shuttering ON or shuttering OFF a TOF 3D camera is understood to include shuttering ON and OFF the camera using any methods or devices known in the art, irrespective of whether or not specific reference is made to a “separate” shutter.

To determine distances to features in scene 30, controller 24 controls light source 26 to transmit a train 40 of transmitted light pulses 41, to illuminate scene 30. Transmitted light pulses 41 are schematically represented by rectangular pulses associated with an overhead arrow 42 indicating direction of propagation of the light pulses. Features in scene 30 reflect light from each transmitted light pulse 41 towards TOF 3D camera 20 as a reflected light pulse.

In FIG. 1A, exemplary features 131 and 132 comprised in objects 31 and 32 respectively are schematically shown reflecting light from transmitted light pulses 41 as trains 45 and 46 of reflected light pulses 47 and 48 respectively. Overhead arrows 67 and 68 schematically indicate direction of propagation of light pulses 47 and 48 respectively. Reflected light pulses, such as light pulses 47 and 48 generally have reduced intensity compared to transmitted light pulses 41 from which they were reflected but substantially a same pulse width and a same pulse shape as the transmitted light pulses. Light pulses used in a TOF 3D camera, such as transmitted light pulses 41 used by TOF 3D camera 20, typically have a pulse width between about 5 and 10 ns (nanoseconds).

Upon lapse of a predetermined exposure delay, “T_{L},” after a time at which each transmitted light pulse 41 is transmitted, controller 24 opens shutter 25 to shutter ON TOF 3D camera 20 for a short exposure period. Typically the short exposure period has a duration between about 10 ns and 20 ns and may have duration equal to the pulse width of transmitted light pulses 41. The short exposure period is used to determine how long it takes light to propagate from TOF 3D camera 20 in a transmitted light pulse 41 and return to the camera in a reflected light pulse. Light in a reflected light pulse from a given feature in scene 30 that reaches TOF 3D camera 20 during the short exposure period following a transmitted light pulse 41 from which it was reflected is registered by a pixel 23 on which the camera images the given feature. An amount of light from a reflected light pulse that is registered during the short exposure period is substantially proportional to a convolution between the reflected light pulse and the exposure period. Reflected light registered by the pixel responsive to all transmitted light pulses 41 in light pulse train 40 provides a measure of the round trip transit time of light from TOF 3D camera 20 to the feature and back to the camera, and may be used to determine a distance to the feature imaged on the pixel.

For example, light in reflected light pulses 47 from feature 131 is imaged on, and registered by a pixel 23 designated 23-131 in FIG. 1A, and light in reflected light pulses 48 from feature 132 is imaged on, and registered by a pixel designated 23-132 in the figure. The amounts of light registered by pixels 23-131 and 23-132 are substantially proportional to the convolutions of exposure periods of TOF 3D camera 20 with reflected light pulses 47 and 48. The convolutions are a function of the round trip transit times of light from light source 26 to features 131 and 132 and back from the features to TOF 3D camera 20. The amounts of light registered by pixels 23-131 and 23-132 during the exposure periods provide measures of the convolutions and are used, optionally by controller 24, to determine distances from TOF 3D camera 20 to features 131 and 132 respectively.

Let the pulse width of a transmitted light pulse 41 and duration of a short exposure period following each transmitted light pulse 41 be the same and equal to “τ”. Let distance to a feature, “f”, such as feature 131 or 132, in scene 30 be “D(f),” and an amount of reflected light registered by a pixel that images the feature be “Q(f)”. Then distance D(f) may be given by an expression,

D(f)=cT_{L}/2±(cτ)(1−Q(f)/Q_{O}(f))/2. 1)

In equation 1 “c” is the speed of light, and “Q_{O}(f)” is an amount of light that would be registered by the pixel were reflected light pulses from the feature to be temporally coincident with the short exposure periods. Various methods are known in the art to determine Q_{O}(f) and when the plus or minus sign in the expression for D_{f} applies. Q_{O}(f) is generally determined by controlling TOF 3D camera 20 to transmit a pulse train of light pulses having pulse width τ and registering light from features during long exposure period of the camera following transmission of each light pulse.

By way of example, equation 1) may be written for distance, “D(131)”, of feature 131 (schematically shown imaged on pixel 23-131 in FIG. 1A) from TOF 3D camera 20 as

D(131)=cT_{L}/2±(cτ)(1−Q(23-131)Q_{O}(23-131)/2. 2)

In general, a TOF 3D camera operating with transmitted light pulse width, “τP”, and an exposure period duration “τ_{E}” may provide distances to features in a scene located between a nearest distance, D_{N}=c(T_{L}−τ_{P})/2, and a farthest, D_{F}=c(T_{L}+τ_{E})/2 from the TOF 3D camera. A dynamic distance range “DDR” of the TOF 3D camera is therefore equal to about (τ_{P}+τ_{E})/2. For TOF 3D camera 20 operating as described above with τ_{P}=τ_{E}=τ, DDR=cτ.

FIG. 1B shows a timeline graph 200 that schematically illustrates relative timing of transmitted light pulses 41 in light pulse train 40, exposure periods of TOF 3D camera 20, and reflected light pulses 47 and 48. The graph schematically illustrates convolutions between transmitted light pulse 47 and 48 and short exposure periods of TOF 3D camera 20. Timeline graph 200 comprises timelines 202, 204, 206, and 208.

Transmitted light pulses 41 are schematically represented by rectangles along timeline 202 and are indicated as having a light pulse width τ. Short exposure periods are schematically represented by dashed rectangles 49 along timeline 204 and are indicated as having duration τ. A short exposure period 49 is associated with each transmitted light pulse 41, and is indicated as starting following a exposure delay T_{L} after the light pulse 41 is transmitted. Reflected light pulses 47 and 48 reflected by features 131 and 132 respectively from transmitted light pulses 41 are shown along timelines 206 and 208. Short exposure periods 49 shown along timeline 204 are reproduced along timelines 206 and 208 to show relative timing between the short exposure periods and reflected light pulses 47 and 48. Height of reflected light pulses 47 and 48 in FIG. 1B is smaller than height of short exposure periods 49 for convenience of presentation and to distinguish the reflected light pulses from the exposure periods. Height of the reflected light pulses 47 and 48 is smaller than that of transmitted light pulses 41 to indicate that intensity of the reflected light pulses is less than that of the transmitted light pulses.

A shaded area A(23-131) of a reflected light pulse 47 in a region of the light pulse that temporally overlaps a short exposure period 49, indicates a magnitude of a convolution between reflected light pulse 47 and short exposure period 49. An amount of light, “Q(23-131)”, in reflected light pulse 47 that is registered by pixel 23-131, which images feature 131, is proportional to the convolution and is represented by shaded area A(47-49) in FIG. 1B. A duration of the overlap is equal to τQ(23-131)/Q_{O}(23-131), which is a term in the equation 2) for D(131). As noted above, Q_{O}(23-131) is an amount of light that would be registered by pixel 23-131 were light pulse 47 completely coincident with short exposure period 49.

Similarly, a magnitude of the convolution between a reflected light pulse 48 from feature 132 and a short exposure period 49 is indicated by a shaded area A(23-132) of reflected light pulse 48 in a region of reflected light pulse 48 that temporally overlaps the exposure period. An amount of light, Q(23-132), in reflected light pulse 48 that is registered by pixel 23-132, which images feature 132, is proportional to the convolution and shaded area A(48-49). A duration of the overlap is equal to τQ(23-132)/Q_{O}(23-132) in the equation for D_{f}.

In FIG. 1A feature 132 is shown closer to TOF 3D camera 20 than is feature 131 and for a given transmitted light pulse 41, a reflected light pulse 48 arrives at TOF 3D camera 20 earlier than a reflected light pulse 47 from feature 131. As a result, for exposure delay T_{L}, reflected light pulse 48 overlaps its associated exposure period 49 less than reflected light pulse 47, and an amount of reflected light registered by pixel 23-132 is less than an amount of reflected light registered by pixel 32-131. Area A(48-49), which provides a measure of reflected light registered by pixel 23-132 is therefore smaller than area A(47-49), which provides a measure of reflected light registered by pixel 23-131.

In FIG. 1A and FIG. 1B transmitted light pulses 41 and reflected light pulses 47 and 48 are shown as ideal square pulses with substantially zero rise times, zero fall times, and perfectly uniform intensities. Exposure periods 49 are also shown as ideal and having a perfectly rectangular shape with sensitivity of pixels 23 in TOF 3D camera 20 rising with zero rise time at an ON time of an exposure period to maintain a constant sensitivity for a duration of the exposure period until an OFF time of the exposure period. At the OFF time sensitivity for registering light falls abruptly to zero with zero fall time. However, practical light pulses and exposure periods have non-zero rise and fall times, and generally do not respectively provide ideally uniform intensities and sensitivities.

In general, it is advantageous for determining distances to features in a scene that light pulses transmitted by a TOF 3D camera, such as TOF 3D camera 20, to illuminate the scene have a pulse shape that matches a shape of the short exposure periods during which light reflected from the transmitted light pulses is registered. In many situations, to provide improved accuracy and resolution of distance measurements provided by a TOF 3D camera, it is advantageous that the transmitted light pulse shape be similar to, or substantially the same as, the shape of the exposure periods.

However, light pulses transmitted by a TOF 3D camera are generally provided by light sources comprising lasers or light emitting diodes coupled to switching circuitry that is subject to inductances, capacitances, and resistances that are not readily adjusted. As a result, it may often be impractical to adjust transmitted light pulse shapes provided by the light sources so that they have a desired pulse shape that may be matched to exposure periods of a TOF 3D camera.

FIG. 2 shows a timeline graph 300 that schematically illustrates relative timing of transmitted and reflected light pulses, and exposure periods for TOF 3D camera 20 imaging scene 30 and objects 31 and 32 (FIG. 1A) with light pulses having pulse shapes substantially different from a shape of exposure periods of the TOF 3D camera. Timeline graph 300 comprises timelines 302, 304, 306, and 308.

Light source 26 (FIG. 1A) transmits light pulses that are schematically represented by small rectangles 341 shown along timeline 302 and are assumed by way of example to have a pulse width equal to about τ/3. Short exposure periods of TOF 3D camera 20 that are associated with transmitted light pulses 341 have non-zero rise and fall times and are schematically represented by dashed trapezoids 349 along timeline 304. Short exposure periods 349 are assumed to have a pulse width τ, and each has an ON time that is delayed from a transmission time of its associated transmitted light pulse 341 by a same exposure delay T_{L}. Light pulses reflected from transmitted light pulses 341 by features 131 and 132 (FIG. 1A) are represented by rectangles 347 and 348 along timelines 306 and 308 respectively. Dashed trapezoids 349 representing exposure periods of TOF 3D camera 20 that are associated with transmitted light pulses 341 are reproduced along timelines 306 and 308 to illustrate relative timing of the reflected light pulses and the exposure periods.

TOF 3D camera 20 operating with light pulses 341 having pulse width τ_{P}=τ/3 and exposure period duration τ_{D}=τ, has a dynamic range DDR, ignoring effects of rise and fall times, that may be given, as noted above, by an expression DDR=c(τ+τ/6)/2. Under the operating conditions that apply for FIG. 2, DDR of TOF 3D camera 20 is about 7/12 that of TOF 3D camera 20 operating under the operating conditions that apply for FIG. 1B.

Light in reflected light pulses 347 and 348 arrive at TOF 3D camera 20 following a same round trip time as light in reflected light pulses 47 and 48 (FIG. 1A) respectively and exposure periods 49 (FIG. 1B) and 349 occur following a same exposure delay T_{L} relative to a transmission time of their associated transmitted light pulses 41 and 341. As a result of the reduced DDR noted above that characterizes operation of TOF 3D camera with transmitted light pulses 341 and exposure periods 349, reflected light pulses 347 and 348 have no temporal overlap with their associated exposure periods 349. Therefore no light is registered from features 131 and 132 by TOF 3D camera 20 operating under the conditions on which timeline graph is based and the TOF 3D camera does not provide distance measurements to features 131 and 132.

A TOF 3D camera, such as TOF 3D camera 20, may not be limited to using a single exposure delay. TOF 3D camera 20 may function to determine distances to features 131 and 132 using an exposure delay T_{L} shorter than that shown in FIGS. 1A and 2. For the shorter exposure delay sufficient temporal overlap may exist between exposure periods 349 and reflected light pulses 347 and 348 to provide distances to features 131 and 132. However, because of the mismatch between pulse length of transmitted light pulses 341 and exposure periods 349, and mismatch between their shapes, convolutions between light pulses reflected from transmitted light pulses 341 and exposure periods 349 are generally less sensitive to differences in distances of features in scene 30 than are convolutions for matched light pulses and exposure periods. For operation of TOF 3D camera 20 with transmitted light pulses 341 and exposure periods 349 therefore, resolution and accuracy for measurements it produces for distances to features 131 and 132 are generally impaired relative to resolution and accuracy obtained with transmitted light pulses 41 and exposure periods 49 shown in FIG. 1B.

FIG. 3A shows a timeline graph 400 that schematically illustrates operating TOF 3D camera 20 to image scene 30 (FIG. 1A) with an emulated transmitted light pulse having a pulse shape matched to the shape of the TOF 3D camera's exposure periods, in accordance with an embodiment of the invention.

In FIG. 3A, TOF 3D camera 20 is assumed to illuminate scene 30 with a train of light pulses comprising transmitted light pulses 441, 442, . . . , 446, and to image light reflected from the transmitted light pulses by features in scene 30 during short exposure periods 451, 452, . . . , 456 that are respectively associated with transmitted light pulses 441, 442, . . . , 446. Transmitted light pulses 441, . . . , 446 are assumed by way of example, to have a same pulse shape as transmitted light pulses 341 shown in FIG. 2, and exposure periods 451, 452, . . . , 456 are assumed to have a same shape as that of exposure periods 349 shown in FIG. 2.

Light reflected from transmitted light pulses 441, . . . , 446 by feature 131 in scene 30 (FIG. 1A) propagates to TOF 3D camera 20 as reflected light pulses 541, 542, . . . , 546 respectively, which are schematically shown as rectangular pulses along timeline 406. Similarly, light reflected from transmitted light pulses 441, . . . , 446 by feature 132 propagates to TOF 3D camera 20 as reflected light pulses 641, 642, . . . , 646 respectively that are schematically shown as rectangular pulses along timeline 408.

In accordance with an embodiment of the invention, controller 24 controls light source 26 and/or shutter 25 (FIG. 1A) to adjust exposure delays between light pulses transmitted by light source 26 to illuminate scene 30 and ON times of their associated exposure periods by different perturbation periods. The perturbation periods are determined so that reflected light pulses reflected by a given feature in scene 30 from different transmitted light pulses arrive at different times relative to the ON times of their respective associated exposure periods and provide an emulated light pulse having a desired pulse shape.

By way of example, in FIG. 3A controller 24 optionally controls timing of exposure periods 451, . . . , 456 so that they repeatedly occur with a fixed period. Witness lines 410 shown along timeline 402 indicate “standard” transmission times for transmitted light pulses 441, 442, . . . , 446 transmitted by light source 26. For a light pulse transmitted at a standard transmission time indicated by witness line 410 by light source 26, an exposure delay to an associated exposure period is equal to T_{L}. In accordance with an embodiment of the invention, to provide a desired emulated light pulse, controller 24 delays transmission of transmitted light pulses 441, 442, 443, 444, 445, and 446 relative to the standard transmission times indicated by witness lines 410 by perturbation periods equal to 0, τ/2, τ, τ, 3τ/2, and 2τ respectively. Exposure delays between transmitted light pulses 441, . . . 446, and their respective associated exposure periods 451, . . . , 456, are therefore, as indicated in timeline graph 400, equal to T_{L}, (T_{L}−τ/2), (T_{L}−τ), (T_{L}−τ), (T_{L}−3τ/2), and (T_{L}−2τ).

Reflected light pulses 541, . . . , 546 reflected by feature 131 reach pixel 23-131 (FIG. 1A) of TOF 3D camera 20 relative to the ON times of their associated exposure periods at times that are perturbed by the perturbation periods of their associated transmitted light pulses. For example, assume that reflected light pulse 541, for which the perturbation period of its associated transmitted light pulse 441 is 0, arrives at pixel 23-131 at a time “Tₐ” relative to the ON time of its associated exposure period 451. Then reflected light pulses 542, 543, 544, 545, and 546 arrive at pixel 23-131 at times, (Tₐ−τ/2), (Tₐ−τ), (Tₐ−τ), (Tₐ−3τ/2), and (Tₐ−2τ) respectively. Whereas reflected light pulses 541 and 542 arrive prior to the ON times of their respective associated exposure periods 451 and 452, and light they contain is therefore not registered by pixel 23-131, light in portions of reflected light pulses 543, 544, 545, and 546 arrives during exposure periods 453, 454, 455, 456, and portions of the light they contain are registered by pixel 23-131.

Transmitted light pulses 441, . . . , 446 provide an emulated light pulse in accordance with an embodiment of the invention. The emulated light pulse comprises a time ordered sum of the light in light pulses 441, . . . , 446 for which each light pulse 441, . . . , 446 contributes to the sum at a time delayed from a leading edge of the emulated light pulse that is equal to its perturbation period. The leading edge of the emulated light pulse is a leading edge of a transmitted light pulse, an “earliest” transmitted light pulse, that contributes to the emulated light pulse, which in FIG. 3A is light pulse 441. The leading edge of transmitted light pulse 441 is its transmission time, which in FIG. 3A is coincident with its associated standard transmission time indicated by witness line 410. An amount of light from reflected light pulses 541, 542, 543, 544, 545, and 546 that reaches and is registered by pixel 23-131 is a same amount of light which pixel 23-131 would register from a reflection of a single light pulse that has a pulse shape identical to the emulated light pulse and is transmitted by light source 26 at a transmission time at which transmitted light pulse 441 is transmitted.

Similarly, An amount of light that pixel 23-132 registers from reflected light pulses 641, 642, 643, 644, 645, and 646 that reaches and is registered by pixel 23-132 is a same amount of light which pixel 23-131 would register from a reflection of the emulated light pulse provided by transmitted light pulses 441, . . . , 446.

FIG. 3B shows a timeline graph 500 that reproduces timelines 402, 406 and 408 from timeline graph 400 in FIG. 3A and schematically shows an emulated transmitted light pulse 440 provided by transmitted light pulses 441, . . . , 446. Emulated transmitted light pulse 440 comprises transmitted light pulses 441, . . . , 446 stacked in order of their respective perturbation delays relative to the transmission time of transmitted light pulse 441 indicated by witness line 410 associated with transmitted light pulse 441. Transmitted light pulse 441 is shown in solid lines and light pulses 442, . . . , 446 “virtually” transposed to the transmission time of light pulse 441 to illustrate how they contribute to emulated transmitted light pulse 440 are shown in dashed lines. By choosing perturbation periods in accordance with an embodiment of the invention, as discussed above and as shown in FIGS. 3A and 3B, emulated light pulse 440 has a pulse width τ equal to the duration of exposure periods 451, . . . , 456 and a trapezoidal shape similar to that of the exposure periods.

Reflection of light in emulated transmitted light pulse 440 by feature 131 is schematically shown as an “emulated reflected light pulse” 540. Emulated reflected light pulse 540 is a compound pulse formed from reflected light pulses 541, . . . , 546 similarly to the manner in which emulated transmitted light pulse 440 is formed from transmitted light pulses 441, . . . , 446. An amount of reflected light from reflected light pulses 541, . . . , 546 registered by pixel (23-131) that images feature 131 (FIG. 1A) is equal to a convolution of emulated reflected light pulse 540 with exposure period 451. A shaded area A*(23-131) of emulated reflected light pulse 540 represents that portion of emulated reflected light pulse 540 that contributes to the convolution.

Similarly, an amount of reflected light from reflected light pulses 641, . . . , 646 registered by pixel (23-132) that images feature 132 (FIG. 1A) is equal to a convolution of emulated reflected light pulse 640 with exposure period 451. A shaded area A*(23-132) of emulated reflected light pulse 640 represents that portion of emulated reflected light pulse 640 that contributes to the convolution.

It is noted that for the operating conditions of TOF 3D camera 20 that apply for FIG. 2 and

FIGS. 3A and 3B TOF 3D camera 20 illuminates scene 30 with transmitted light pulses having a same pulse width τ/3. However, by temporally configuring transmitted light pulses 441, . . . , 446 to provide an emulated reflected light pulse 540 having a pulse width T, in accordance with an embodiment of the invention, the dynamic distance range DDR, of TOF 3D camera is substantially increased. Whereas, as noted above, TOF 3D camera 20 has a DDR equal to about ( 7/12)cτ under the operating conditions that apply for FIG. 2, the TOF 3D camera has a DDR equal to about cτ under the operating conditions that apply for FIGS. 3A and 3B, which provide emulated transmitted light pulse 540. Under the operating conditions that apply for FIG. 2 distance measurements to features 131 and 132 cannot be acquired but distance measurements may be acquired under the operating conditions, which provide an emulated transmitted light pulse in accordance with an embodiment of the invention that apply for FIGS. 3A and 3B

Whereas in the description above, transmitted light pulses are timed to provide an emulated light pulse having a pulse shape similar to an exposure period, practice of embodiments of the invention are not limited to tailoring light pulses to match a shape of an exposure period. For example, an amount of light from a transmitted light pulse, such as transmitted light pulses 41 and 441 (FIGS. 1A and 3A) that illuminates a feature in scene 30, such as features 131 and 132 in scene 30, typically decreases by the square of a distance of the feature from TOF 3D camera 20. As a result, an amount of light registered by a pixel 23 that images the feature, which is useable to provide a distance to the feature decreases in proportion to a square of the distance of the feature from TOF 3D camera 20.

In an embodiment of the invention, to moderate a reduction in registered light with distance, an emulated transmitted light pulse is configured to have a greater amount of light in a trailing half of the emulated transmitted light pulse than in a leading half of the emulated light pulse. Optionally, the emulated transmitted light pulse has a parabolic shape, for which intensity of light in the emulated transmitted light pulse increases substantially quadratically with displacement from a trailing edge of the light pulse.

For example, light reflected from a transmitted light pulse by features relatively close to TOF 3D camera 20 that reaches and is registered by TOF 3D camera 30 during the camera's exposure periods is typically light reflected predominantly from portions of the transmitted light pulses closer to the trailing edges of the light pulses. On the other hand, light reflected from a transmitted light pulse by features relatively far from TOF 3D camera 20 that reaches and is registered by TOF 3D camera 20 during the camera's exposure periods is typically light reflected from portions of the transmitted light pulse closer to the leading edges of the light pulses. Therefore, an emulated transmitted light pulse having more light in its trailing half than in its leading half, in accordance with an embodiment of the invention, operates to moderate decrease in registered light with distance. An emulated light pulse having a parabolic pulse shape that increases substantially quadratically with displacement from a trailing edge of the light pulse provides illumination of features in scene 30 for TOF 3D camera 20 that operates to substantially match and cancel the inverse square falloff of illumination with distance, and provide illumination of scene 30 that may appear similar to ambient illumination.

By way of example, FIG. 4 schematically shows an emulated light pulse 666 comprising light pulses 667 that has a shape 668 similar to a parabolic shape, for which intensity of light in the emulated light pulse increases substantially quadratically with displacement from a trailing edge 701 of the emulated light pulse to a leading edge 702 of the emulated light pulse.

It is noted that whereas emulated light pulse 666 is discussed in a context of a TOF 3D camera, an emulated light pulse similar to emulated light pulse 666 may be advantageous for use with a camera that provides contrast images, that is “pictures” of a scene. Light pulses similar to emulated light pulse 666 may provide advantageous illumination of features in a scene that are relatively far from the “contrast” camera.

In the description and claims of the present application, each of the verbs, “comprise” “include” and “have”, and conjugates thereof, are used to indicate that the object or objects of the verb are not necessarily a complete listing of components, elements or parts of the subject or subjects of the verb.

Descriptions of embodiments of the invention in the present application are provided by way of example and are not intended to limit the scope of the invention. The described embodiments comprise different features, not all of which are required in all embodiments of the invention. Some embodiments utilize only some of the features or possible combinations of the features. Variations of embodiments of the invention that are described, and embodiments of the invention comprising different combinations of features noted in the described embodiments, will occur to persons of the art. The scope of the invention is limited only by the claims.

1. A method of imaging a scene with light the method comprising:
illuminating a scene with a train of transmitted light pulses;
shuttering ON a camera for an exposure period characterized by an exposure period shape upon lapse of an exposure delay from a time at which each light pulse in the train of light pulses is transmitted to register light from the transmitted light pulse that is reflected by features in the scene; and
adjusting the exposure delays by perturbation time periods so that a sum of the intensities of the transmitted light pulses, time ordered relative to a common time origin by their respective perturbation time periods, provides an emulated light pulse having a desired pulse shape.

2. A method according to claim 1 wherein the emulated light pulse has a pulse shape similar to the exposure period shape.

3. A method according to claim 1 wherein the emulated light pulse has a pulse shape that represents a light pulse having a greater amount of light in a leading half of the light pulse than in a trailing half of the light pulse.

4. A method according to claim 3 wherein the pulse shape increases quadratically with displacement from a trailing of the emulated light pulse toward a leading edge of the emulated light pulse.

5. A method according to claim 1 wherein the light pulses have a pulse width smaller that a width of the exposure periods and the emulated light pulse has a pulse width substantially equal to the width of the exposure periods.

6. A method according to claim 1 wherein the camera comprises a time of flight (TOF) three dimensional (3D) camera that uses light registered by the camera to determine distances to features in the scene.

7. A method according to claim 1 wherein the camera uses registered light to provide contrast images of the scene.

8. A time of flight (TOF) three dimensional (3D) camera that provides distances to features in a scene that the camera images, the camera comprising:
a light source controllable to transmit a train of light pulses to illuminate the scene;
a photosensor having pixels that register light incident on the pixels an optical system that images light reflected by features in the scene from the transmitted light pulses on the pixels;
a shutter controllable to shutter ON and shutter OFF the camera to provide the camera with exposure periods; and
a controller that:
controls the light source to illuminate the scene with a train of transmitted light pulses;
controls the shutter to shutter ON the camera for an exposure period characterized by an exposure period shape upon lapse of an exposure delay from a time at which each light pulse in the train of light pulses is transmitted to register light from the transmitted light pulse that is reflected by features in the scene; and
adjusts the exposure delays by perturbation time periods so that a sum of the intensities of the transmitted light pulses, time ordered relative to a common time origin by their respective perturbation time periods, provides an emulated light pulse having a desired pulse shape.

9. A TOF 3D camera according to claim 8 wherein the emulated light pulse has a pulse shape similar to the exposure period shape.

10. A TOF 3D camera according to claim 8 wherein the emulated light pulse has a pulse shape that that represents a light pulse having a greater amount of light in a leading half of the light pulse than in a trailing half of the light pulse.

11. A TOF 3D camera according to claim 10 wherein the pulse shape increases substantially quadratically with displacement from the trailing of the emulated light pulse to the leading edge of the emulated light pulse.

12. A TOF 3D camera according to claim 8 wherein the light pulses have a pulse width smaller that a width of the exposure period and the emulated light pulse has a pulse width substantially equal to the exposure period width.

13. A camera comprising:
a light source controllable to transmit a train of light pulses to illuminate the scene;
a photosensor having pixels that register light incident on the pixels
an optical system that images light reflected by features in the scene from the transmitted light pulses on the pixels;
a shutter controllable to shutter ON and shutter OFF the camera to provide the camera with exposure periods; and
a controller that:
controls the light source to illuminate the scene with a train of transmitted light pulses;
controls the shutter to shutter ON the camera for an exposure period characterized by an exposure period shape upon lapse of an exposure delay from a time at which each light pulse in the train of light pulses is transmitted to register light from the transmitted light pulse that is reflected by features in the scene; and
adjusts the exposure delays by perturbation time periods so that a sum of the intensities of the transmitted light pulses, time ordered relative to a common time origin by their respective perturbation time periods, provides an emulated light pulse having a desired pulse shape.

14. A TOF 3D camera according to claim 13 wherein the emulated light pulse has a pulse shape similar to the exposure period shape.

15. A TOF 3D camera according to claim 13 wherein the emulated light pulse has a pulse shape that that represents a light pulse having a greater amount of light in a leading half of the light pulse than in a trailing half of the light pulse.

16. A TOF 3D camera according to claim 14 wherein the pulse shape increases substantially quadratically with displacement from the trailing of the emulated light pulse to the leading edge of the emulated light pulse.

17. A TOF 3D camera according to claim 13 wherein the light pulses have a pulse width smaller that a width of the exposure period and the emulated light pulse has a pulse width substantially equal to the exposure period width.
